(19) United States
(12) Patent Application Publication
(10) Pub. No.: US 2015/0141303 A1
(43) Pub. Date: May 21, 2015

(54) BINARY AND TERNARY SURFACTANT BLENDS FOR ENHANCED OIL RECOVERY IN RESERVOIR BRINES WITH EXTREMELY HIGH TOTAL DISSOLVED SOLIDS

(71) Applicant: The Board of Regents of the University of Oklahoma, Norman, OK (US)

(72) Inventors: Jeffrey H. Harwell, Norman, OK (US); Tzu-Ping Hsu, Norman, OK (US); Bruce L. Roberts, Norman, OK (US); Bor-Jier Shiau, Norman, OK (US); Mahesh Budhathoki, Norman, OK (US); Prapas Lohateeraparp, Houston, TX (US)

(21) Appl. No.: 14/546,972

(22) Filed: Nov. 18, 2014

Related U.S. Application Data
(60) Provisional application No. 61/905,735, filed on Nov. 18, 2013.
(60) Provisional application No. 61/905,702, filed on Nov. 18, 2013.
(60) Provisional application No. 61/905,700, filed on Nov. 18, 2013.
(60) Provisional application No. 61/905,692, filed on Nov. 18, 2013.

(51) Int. Cl. C09K 8/584

(52) U.S. Cl. CPC C09K 8/584
USPC 507/255

(57) ABSTRACT

A binary or ternary surfactant mixture for use in enhanced oil recovery within a reservoir having total dissolved solids greater than approximately 80,000 parts per million (i.e., heavy to extreme brine conditions) includes at least two of a propoxylated/ethoxylated alcohol sulfate, an ethoxylated alcohol sulfate, and a monoalkyl or dialkyl diphenyloxide disulfonate. The surfactant mixture is used without alcohol, which is unnecessary to maintain solution stability and good coalescence rates and thus improves compatibility with polymers added to improve the mobility ratio. During testing, exceptional solution stability, excellent oil recovery capability, and good compatibility was observed with these surfactant blends. The mixtures are effective at concentrations below 1% and as low as 0.1% by weight.

The present application claims priority to U.S. Provisional Patent Application Ser. No. 61/905,735 entitled “BINARY AND TERNARY SURFACTANT BLENDS FOR ENHANCED OIL RECOVERY IN RESERVOIR BRINES WITH EXTREMELY HIGH TOTAL DISSOLVED SOLIDS,” filed Nov. 18, 2013. The content of the above-identified patent document is incorporated herein by reference. The present application also claims priority to and incorporates by reference the content of U.S. Provisional Patent Application Ser. No. 61/905,702 entitled “SURFACTANT FLOODING IN A HIGH SALINITY RESERVOIR WITH A BINARY MIXTURE OF AN ETHOXYLATED/PROPOXYLATED ALCOHOL SULFATE AND AN ETHOXYLATED ALCOHOL SULFATE WITHOUT ADDED ALCOHOL OR COSOLVENT,” filed Nov. 18, 2013, U.S. Provisional Patent Application Ser. No. 61/905,700 entitled “DEVELOPMENT OF WINDSOR TYPE I MICROEMULSIONS FOR EOR APPLICATIONS,” filed Nov. 18, 2013, and U.S. Provisional Patent Application Ser. No. 61/905,692 entitled “SURFACTANT BLENDS FOR CHEMICAL ENHANCED OIL RECOVERY,” filed Nov. 18, 2013.

### TECHNICAL FIELD

The present disclosure relates generally to use of surfactants in enhanced oil recovery and, more specifically, to surfactant blends targeting specific reservoir chemistry.

### BACKGROUND

Enhanced oil recovery by chemical flooding with surfactant and surfactant/polymer blends began in the 1970s, and has continued to be an area of research for the last 40 years, though with generally decreased emphasis after the early 1980s. It has become an important topic again only with the great increase in oil prices, especially that which has occurred since 2006/2008.

One of the most challenging tasks for chemical flooding for enhanced oil recovery (EOR) applications is extreme total dissolved solids (TDS) levels in reservoir brines—that is, solids of more than 200,000 milligrams/Liter (mg/L). It is not uncommon to observe more than 250,000 mg/L of TDS in some reservoir brines (e.g., a site near the panhandle of Oklahoma).

Conventional EOR surfactant systems cannot survive under these extreme conditions without markedly reduced solution stability (e.g., formation of separate phases or precipitates).

There is, therefore, a need in the art for a novel surfactant for high TDS reservoir brines.

### SUMMARY

A binary or ternary surfactant mixture for use in enhanced oil recovery within a reservoir having total dissolved solids greater than approximately 150,000 parts per million (i.e., extreme brine conditions) includes at least two of a propoxylated/ethoxylated alcohol sulfate, an ethoxylated alcohol sulfate, and a monoalkyl or dialkyl diphenyloxide disulfonate. The surfactant mixture is used without alcohol, which is unnecessary to maintain solution stability and good coalescence rates and thus improves compatibility with polymers added to improve the mobility ratio. During testing, exceptional solution stability, excellent oil recovery capability, and good compatibility was observed with these surfactant blends. The mixtures are effective at concentrations below 1% and as low as 0.1% by weight.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. It should be noted that definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified diagram illustrating a process for employing an improved surfactant blend for chemical enhanced oil recovery in accordance with various embodiments of the present disclosure.

### DETAILED DESCRIPTION

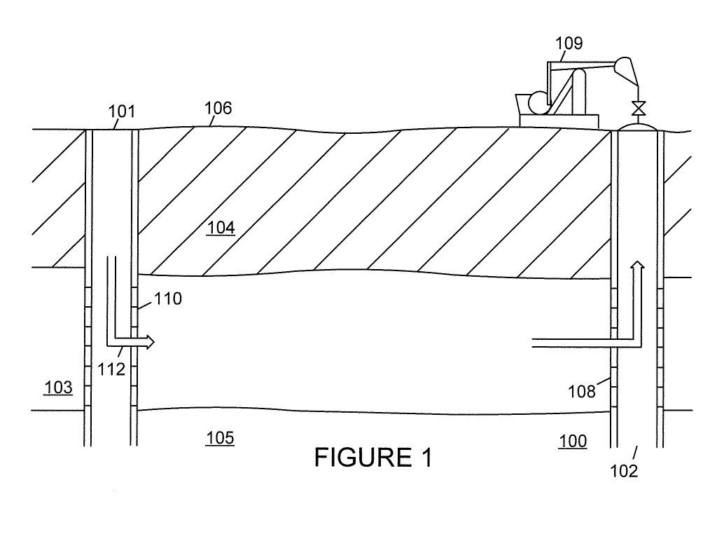

FIG. 1, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

In this disclosure, a new surfactant system is presented that can produce an enhanced oil recovery/mobilization by achieving an ultra-low interfacial tension (IFT) micro-emulsion while maintaining solution stability at extremely high TDS brine conditions (>250,000 mg/L). The developed surfactant blends involve binary or ternary surfactant mixtures of a propoxylated/ethoxylated alcohol sulfate (or so called extended surfactants), an ethoxylated alcohol sulfate, and a monoalkyl or dialkyl diphenyloxide disulfonate or some combination of each group. The developed surfactant blends exhibit exceptional solution stability, excellent oil recovery capability, and good compatibility. These systems also do not require the addition of alcohol or solvent to maintain solution stability and good coalescence rates, which improves their compatibility with polymers added to improve the mobility ratio. Thus, these new surfactant blends could be great candidates for EOR applications under extreme brine conditions. While reservoirs in Western Oklahoma are particularly suited for use of the surfactant blend, similar conditions are found world-wide. The formulation is also effective at concentrations below 1% by weight, possibly as low as 0.1%. This is very important to the economic feasibility of the technology.

FIG. 1 is a simplified diagram illustrating a process for employing an improved surfactant blend for chemical enhanced oil recovery in accordance with various embodiments of the present disclosure. In the system 100 depicted, an injector well 101 into a subterranean formation including an oil reservoir is located in proximity to a production well 102. Injector well 101 may be located some distance away from production well 102, on the order of several hundred feet or more. Both wells 101, 102 are drilled into a permeable subterranean formation 103, which may contain an underground oil reservoir and may extend from an overburden layer 104 to an underburden layer 105. While wells 101, 102 are depicted as substantially vertical in FIG. 1, other well configurations, including wells forming various angles with an outer or top surface 106 of the Earth, are within the scope of this disclosure. Additionally, within the context of this disclosure, the term “injector well” is defined broadly to include any channel, tunnel or hole, either man-made or naturally occurring, of sufficient size and location with respect to a subterranean oil reservoir to facilitate enhanced oil recovery.

As shown in FIG. 1, the borehole of production well 102 may be supported by a casing having a perforated region 108. A pump 109 located on the surface may be used to extract oil that flows into borehole 102 through the perforated casing from the subterranean formation 103. The borehole of injection well 101 may likewise have a casing with a perforated region 110 to permit fluids (including surfactants 112) that are injected into injection well 101 to flow into the portion of the subterranean formation 103 between the two wells. In most instances of interest for purposes of the present disclosure, injector well 101 will be a distance from production well 102 that supports enhanced extraction of oil from an oil reservoir of the subterranean formation 103 using surfactants 112. The oil reservoir will generally be resident within and may be part of subterranean formation 103, and is typically located generally below and between injector well 101 and production well 102.

In accordance with the present disclosure, to enhance recovery of oil from an oil reservoir of subterranean formation 103, injection of fluids including surfactants 112 to maintain pressure of the oil reservoir within subterranean formation 103 may be accomplished by injecting fluids including surfactants 112 that form fluid banks within the subterranean formation. The present disclosure relates to a method of injecting a surfactant formulation in an injection well 101 to mobilize and produce stranded oil in the subterranean formation 103 in wells have specific characteristics, including high concentrations of total dissolved solids.

To design a binary surfactant system 112 according to the present disclosure, a hydrophilic-lipophilic difference equation may be employed:

HLD=ln(S*)×K×N_{C,O}−f(A)+Cc−α_{T}(T−25) (1)

where Cc is the Characteristic Curvature value of a surfactant, K is a constant, S* is the optimal salinity, N_{C,O} is a number of carbons in the oil phase (equivalent alkane carbon number or “EACN”), α_{T} is a temperature constant, and T is temperature in degrees Celsius (° C.). For an alcohol-free microemulsion at optimal salinity, equation (1) becomes:

0=ln(S*)−K×N_{C,O}+Cc−α_{T}(T−25) (2)

where the Characteristic Curvature value of a surfactant mixture is determined by

Ccₘᵢₓ=ΣXᵢCcᵢ

where Xᵢ and Ccᵢ are the mole fraction and the Characteristic Curvature, respectively, of each surfactant i. To formulate binary surfactant system 112 for enhanced oil recovery application using equation (2), the following surfactants may be used in deriving possible surfactant systems:

| Surfactant | Abbreviation |
|---|---|
| Sodium sulfosuccinate | SAT |
| Sodium laureth sulfate | SLS |
| Branched sodium diphenyl oxide disulfonate | SDODS |
| Experimental surfactant 1 (extended surfactant 1) | EPS-1 |
| Experimental surfactant 2 (extended surfactant 2) | EPS-2 |
| Experimental surfactant 3 (extended surfactant 3) | EPS-3 |
| Experimental surfactant 4 (extended surfactant 4) | EPS-4 |
| Experimental surfactant 5 (extended surfactant 5) | EPS-5 |
| Experimental surfactant 6 (extended surfactant 6) | EPS-6 |
| Experimental surfactant 7 (extended surfactant 7) | EPS-7 |

EPS-5, EPS-6 and EPS-7 were selected from propoxylated/ethoxylated alcohol sulfates, ethoxylated alcohol sulfates, and monoalkyl or dialkyl diphenyloxide disulfonates. Testing of the surfactant systems may use sodium gluconate, formaldehyde, decane, crude oil from a well site, and brine from the well site. In an exemplary testing arrangement, the crude oil has an equivalent alkane carbon-number (EACN) of 8.5, viscosity of 4.0 centipoises (cP) at the reservoir temperature (42° C.), and an American Petroleum Institute (API) gravity of 40.6. The brine contains a TDS level of 166,192 parts per million (ppm), cation concentrations of 42,490 ppm sodium (Na⁺), 6,863 ppm calcium (Ca²⁺), 1,679 ppm magnesium (Mg²⁺), and 332 ppm potassium (K⁺), and an iron (Fe) concentration of less than 2 ppm.

A first approach uses the TDS of well site as the S*, calculating Ccₘᵢₓ, mix with the following equation:

ln(S*)=K×EACN−Ccₘᵢₓ+α_{T}*ΔT (3)

where the above-identified conditions for the well site (using a value of α_{T}(K⁻¹)=0.01 and K=0.17) results in Ccₘᵢₓ=−1.20.

A second approach uses the Cc of the surfactant formulation that is obtained from conventional method:

Ccₘᵢₓ=x₁Ccᵢ+x₂Cc₂+x₃Cc₃

to obtain Ccₘᵢₓ=−1.13 based on the surfactant mixture below:

| Surfactant | Conc., % | Cc |
|---|---|---|
| Sodium sulfosuccinate | 0.20 | 2.66 |
| Sodium laureth sulfate | 0.25 | −2.36 |
| Branched sodium diphenyl oxide | 0.10 | −6.96 |
| disulfonate | | |

For preliminary testing of a binary surfactant mixture, given Cc values for the surfactants identified previously of

| Surfactant | Cc |
|---|---|
| SAT | 2.66 |
| SLS | −2.36 |
| SDODS | −6.96 |
| EPS-1 | −5.46 |
| EPS-2 | −6.43 |
| EPS-3 | −3.95 |
| EPS-4 | −4.89 |
| EPS-5 | −1.68 |
| EPS-6 | +0.10 |
| EPS-7 | +0.01 |

Targeting Ccₘᵢₓ=−1.13 suggests a few possible combinations:

| Surfactant | Cc > −1.13 |
|---|---|
| SAT | 2.66 |
| EPS-6 | +0.10 |
| EPS-7 | +0.01 |
| SLS | −2.36 |
| SDODS | −6.96 |
| EPS-1 | −5.46 |
| EPS-2 | −6.43 |
| EPS-3 | −3.95 |
| EPS-4 | −4.89 |
| EPS-5 | −1.68 |

During preliminary testing of binary surfactant mixtures, decane was used as oil, and the well site brine was prepared with 200 ppm sodium gluconate and 300 ppm formaldehyde. The total surfactant concentration was 0.1 M. Samples (both the surfactant aqueous solution and the microemulsion) were kept at 42° C.

A phase behavior study of the microemulsion using the binary surfactant system found that the system exhibits a fast coalescence rate with no undesired phase. A precipitation and phase separation study (in aqueous solution) found the system to be chemically stable. Interfacial tension (of the micro-emulsion) was ultralow, determined by either visual observation and measured by spinning drop tensiometer. The results are tabulated below:

| | | Total Surf. | | | Phase | IFT |
|---|---|---|---|---|---|---|
| Surf. 1 | Surf. 2 | Conc. | Ccₘᵢₓ | Precip. | Separation | (mN/m) |
| SAT | SLS | | −1.13 | Yes | Yes | 0.2365 |
| | SDODS | | −1.13 | Yes | Yes | 0.1287 |
| | SDODS | | −1.05 | Yes | Yes | Not ultralow |
| | EPS-2 | | −1.13 | Yes | Yes | 0.1595 |
| | EPS-2 | | −1.03 | Yes | Yes | 0.1707 |
| | EPS-3 | | −1.13 | Yes | Yes | Not ultralow |
| | EPS-4 | | −1.13 | Yes | Yes | Not ultralow |
| | EPS-4 | | −1.52 | Yes | Yes | Not ultralow |
| | EPS-5 | | −1.13 | Yes | Yes | 0.0403 |
| | EPS-5 | | −1.08 | Yes | Yes | 0.0617 |
| | EPS-6 | | −1.13 | Yes | Yes | Not ultralow |
| EPS-6 | SDODS | | −1.13 | No | Yes | Ultralow |
| | EPS-1 | | −1.13 | No | Yes | Ultralow |
| | EPS-4 | | −1.13 | No | Yes | Not ultralow |
| | EPS-5 | | −1.13 | No | Yes | Ultralow |
| EPS-7 | SLS | | −1.13 | Yes | No | Ultralow |
| | SDODS | | −1.13 | Yes | Yes | Not ultralow |
| | EPS-1 | | −1.13 | Yes | Yes | Not ultralow |
| | EPS-2 | | −1.13 | Yes | Yes | Not ultralow |
| | EPS-3 | | −1.13 | Yes | Yes | Not ultralow |
| | EPS-4 | | −1.13 | Yes | Yes | Not ultralow |
| | EPS-5 | | −1.13 | Yes | No | Ultralow |
| EPS-6 | SDODS | 0.1M | −1.13 | No | Yes | Ultralow |
| EPS-6 | EPS-1 | 0.1M | −1.13 | No | Yes | Ultralow |
| EPS-6 | EPS-5 | 0.1M | −1.13 | No | Yes | Ultralow |
| EPS-7 | SLS | 0.1M | −1.13 | Yes | No | Ultralow |
| EPS-7 | EPS-5 | 0.1M | −1.13 | Yes | No | Ultralow |

Where not measured (in milli-Newton per meter), the presence or absence of ultralow interfacial tension was determined by visual observation.

Based upon the above results, the combinations of EPS-6/EPS-5 and EPS-7/EPS-5 were selected for further testing. For the selected binary surfactant material, the well site crude was used as oil, and the well site brine was prepared with 200 ppm sodium gluconate and 300 ppm formaldehyde. The total surfactant concentration was less than 0.5%. Samples (both the surfactant aqueous solution and the microemulsion) were kept at 42° C. Once again, a phase behavior study of the microemulsion using the selected binary surfactant system found that the system exhibited a fast coalescence rate with no undesired phase, a precipitation and phase separation study (in aqueous solution) found the system to be chemically stable, and interfacial tension (of the micro-emulsion, measured by spinning drop tensiometer) was found to be ultralow. The results are tabulated below:

| EPS-6 | | Total | | | | |
|---|---|---|---|---|---|---|
| Conc., | EPS-5 | Surf. | | | Phase | IFT |
| % | Conc., % | Conc., % | Ccₘᵢₓ | Precip. | Separation | (mN/m) |
| 0.05 | 0.16 | 0.21 | −1.26 | No | No | 4.5 × 10⁻³ |
| 0.05 | 0.18 | 0.23 | −1.29 | No | No | 3.7 × 10⁻³ |
| 0.05 | 0.20 | 0.25 | −1.33 | No | No | 1.9 × 10⁻³ |

| EPS-7 | | Total | | | | |
|---|---|---|---|---|---|---|
| Conc., | EPS-5 | Surf. | | | Phase | IFT |
| % | Conc., % | Conc., % | Ccₘᵢₓ | Precip. | Separation | (mN/m) |
| 0.10 | 0.17 | 0.27 | −1.13 | No | No | 5.2 × 10⁻³ |
| 0.10 | 0.19 | 0.29 | −1.17 | No | No | 3.1 × 10⁻³ |
| 0.10 | 0.21 | 0.31 | −1.20 | No | No | 3.4 × 10⁻³ |

Based on the above results, the combination of EPS-6/EPS-5 at 0.05%/0.20% and the combination of EPS-7/EPS-5 at 0.10%/0/19% were selected for sand pack column study. For the 1-D sand pack column study, the well site crude was used as oil, and the well site brine was prepared with 200 ppm sodium gluconate and 300 ppm formaldehyde. Surfactant formulations of (1) 0.053% EPS-6 with 0.197% EPS-5, and (2) 0.095% EPS-7 with 0.19% EPS-5 were tested, with 2,000 ppm biopolymer (Xanthan biopolymer). The packing material used was crushed Berea sand, and the temperature was fixed at 42° C. using a water bath. The injection strategy included 0.5 pore volume (PV) of surfactant/polymer slug at a flow rate of 0.3 milli-liters per minute (mL/min). The results are tabulated below:

| Column | | Residual Oil |
|---|---|---|
| Test # | Surfactant/Polymer System | Recovery, % |
| 1 | 0.5 PV 0.053% EPS-6/0.197% EPS-5 with | 55% |
| | 2,000 ppm biopolymer | |
| 2 | 0.5 PV 0.095% EPS-6/0.19% EPS-5 with | 39% |
| | 2,000 ppm biopolymer | |
| Previous | 0.5 PV 0.20% SAT/0.25% SLS/0.10% SC 01 | 60% |
| | with 2,000 ppm biopolymer | |

For a core flood test, the well site crude was used as oil, and the well site brine was prepared with 200 ppm sodium gluconate and 300 ppm formaldehyde. The surfactant formulation selected was 0.053% EPS-6 with 0.197% EPS-5, with 2,000 ppm biopolymer. The core material was 50 milli-Darcy (mD) Berea core at a temperature of 42° C. using 0.5 PV of surfactant/polymer slug injection strategy at a flow rate of 0.3 mL/min. The results are tabulated below:

| Column | | Residual Oil |
|---|---|---|
| Test # | Surfactant/Polymer System | Recovery, % |
| 1 | 0.5 PV 0.053% EPS-6/0.197% EPS-5 with | 51% |
| | 2,000 ppm biopolymer | |
| Previous | 0.5 PV 0.20% SAT/0.25% SLS/0.10% SC 01 | 64% |
| | with 2,000 ppm biopolymer | |

To formulate surfactant system for EOR applications in which a stable surfactant system in brine is crucial, the HLD equation can be a good tool to help select and design the surfactant formulation since applying the HLD concept can significantly reduce time when compared to the other methods and a brine TDS can be used as the optimal salinity in the HLD equation at high salinity.

As discussed above, chemical enhanced oil recovery is difficult in high salinity reservoirs because of precipitation or phase separation of the surfactant system. The surfactant system described herein is suitable for extremely high salinity reservoir formations under various temperature and pressure conditions (up to 250,000 mg/L total dissolved solids, and reservoir temperature from room temperature to 120° C.). The system disclosed is also suitable for sandstone sedimentary rocks and formations, and effective at low surfactant concentrations (<1% by weight).

The surfactant system of the present disclosure overcomes the challenging issues of extremely high brine reservoirs, e.g., surfactant precipitation/adverse phase separation, and improves the cost effectiveness of the chemical flooding for EOR by using blends of commercially available surfactants at low concentrations. The system disclosed forms the basis for a new generation of surfactant formulations applicable to many mature U.S. domestic oil fields, to recover the residual oil, while the ability to use with produced water reduces process cost by minimizing water treatment requirements. The ability of the disclosed surfactant system to work without addition of low molecular weight alcohol as an additive improves compatibility with polymers to improve sweep.

The present disclosure relates to obtaining ultra-low interfacial tension by concentrating the surfactants at the oil-water interface. Whereas traditional approaches customized the surfactant system based upon salinity, the surfactant system of the present disclosure employs the same surfactants for either water solubility or oil solubility without water treatment, basing only the ratio of the surfactants on salinity and/or solubility limits within the brine. Because the surfactant system is soluble at high salt concentration, fresh water is not needed for the flood; instead, fluid may be simply recycled for surfactant injection. Preferably, one component of the surfactant system should be a hydrophilic linker providing a favorable coalescence rate.

Although the present disclosure has been described with an exemplary embodiment, various changes and modifications may be suggested to one skilled in the art. It is intended that the present disclosure encompass such changes and modifications as fall within the scope of the appended claims

What is claimed is:

1. A method, comprising:
formulating, for introduction into a reservoir having a total dissolved solids (TDS) level greater than approximately 80,000 ppm, a binary or ternary surfactant mixture of at least two of
a propoxylated/ethoxylated alcohol sulfate,
an ethoxylated alcohol sulfate, and
a monoalkyl or dialkyl diphenyloxide disulfonate.

2. The method of claim 1, wherein amounts of the propoxylated/ethoxylated alcohol sulfate, the ethoxylated alcohol sulfate, and the monoalkyl or dialkyl diphenyloxide disulfonate within the surfactant mixture are selected based upon
ln(S*)=K×EACN−Ccₘᵢₓ+α_{T}*ΔT,
where K is a constant, EACN is a number of carbons in an oil phase, α_{T} is a temperature constant, T is temperature in degrees Celsius (° C.) and ΔT is a difference between a temperature of the reservoir and 25° C.,
wherein the total dissolved solids within the reservoir is used for S*, and wherein a Characteristic Curvature value Ccₘᵢₓ of the surfactant mixture is determined by
Ccₘᵢₓ=ΣXᵢCcᵢ,
where Xᵢ and Ccᵢ are a mole fraction and a Characteristic Curvature, respectively, of each surfactant i selected from the group consisting of the propoxylated/ethoxylated alcohol sulfate, the ethoxylated alcohol sulfate, and the monoalkyl or dialkyl diphenyloxide disulfonate.

3. The method of claim 1, wherein the surfactant mixture comprises 0.20% sodium sulfosuccinate, 0.25% sodium laureth sulfate, and 0.10% branched sodium diphenyl oxide disulfonate.

4. The method of claim 1, wherein the surfactant mixture is introduced into the reservoir without concurrently introducing a solvent.

5. The method of claim 1, wherein the surfactant mixture is introduced into the reservoir without concurrently introducing alcohol.

6. The method of claim 1, further comprising:
introducing a surfactant system comprising the surfactant mixture into the reservoir without concurrently introducing alcohol or a solvent.

7. The method of claim 1, further comprising:
adding, to the surfactant mixture, polymers selected to improve a mobility ratio of a surfactant system comprising the surfactant mixture.

8. The method of claim 1, further comprising:
adding the surfactant mixture to a surfactant system to be introduced into the reservoir at a concentration of below 1% by weight.

9. The method of claim 1, further comprising:
adding the surfactant mixture to a surfactant system to be introduced into the reservoir at a concentration of below 0.1% by weight.

10. The method of claim 1, further comprising:
adding the surfactant mixture to a surfactant system comprising a hydrophilic linker.

11. A surfactant mixture for introduction into a reservoir having a total dissolved solids (TDS) level greater than approximately 80,000 ppm, the mixture comprising:
a binary or ternary mixture of at least two of
a propoxylated/ethoxylated alcohol sulfate,
an ethoxylated alcohol sulfate, and
a monoalkyl or dialkyl diphenyloxide disulfonate.

12. The mixture of claim 11, wherein amounts of the propoxylated/ethoxylated alcohol sulfate, the ethoxylated alcohol sulfate, and the monoalkyl or dialkyl diphenyloxide disulfonate within the surfactant mixture are selected based upon
ln(S*)=K×EACN−Ccₘᵢₓ+α_{T}*ΔT,
where K is a constant, EACN is a number of carbons in an oil phase, α_{T} is a temperature constant, T is temperature in degrees Celsius (° C.) and ΔT is a difference between a temperature of the reservoir and 25° C.,
wherein the total dissolved solids within the reservoir is used for S*, and wherein a Characteristic Curvature value Ccₘᵢₓ of the surfactant mixture is determined by
CCₘᵢₓ=ΣXᵢCcᵢ,
where Xᵢ and Ccᵢ are a mole fraction and a Characteristic Curvature, respectively, of each surfactant i selected from the group consisting of the propoxylated/ethoxylated alcohol sulfate, the ethoxylated alcohol sulfate, and the monoalkyl or dialkyl diphenyloxide disulfonate.

13. The mixture of claim 11, wherein the surfactant mixture comprises 0.20% sodium sulfosuccinate, 0.25% sodium laureth sulfate, and 0.10% branched sodium diphenyl oxide disulfonate.

14. A surfactant system for introduction into the reservoir and including the mixture of claim 11, wherein the surfactant system does not include a solvent.

15. A surfactant system for introduction into the reservoir and including the mixture of claim 11, wherein the surfactant system does not include alcohol.

16. A surfactant system within the reservoir and including the mixture of claim 11, wherein the surfactant system does not include alcohol or a solvent.

17. The mixture of claim 11, further comprising:
polymers selected to improve a mobility ratio of a surfactant system comprising the surfactant mixture.

18. A surfactant system including the mixture of claim 11 at a concentration of below 1% by weight.

19. A surfactant system including the mixture of claim 11 at a concentration of below 0.1% by weight.

20. The mixture of claim 11, further comprising:
a hydrophilic linker.
